(19) United States
(12) Patent Application Publication
(10) Pub. No.: US 2004/0251095 A1
(43) Pub. Date: Dec. 16, 2004

(54) Electric vehicle braking system

(75) Inventors: Julien Simard, Brossard (CA); Serge Sarraillon, Varennes (CA)

Correspondence Address: FOLEY AND LARDNER, SUITE 500, 3000 K STREET NW, WASHINGTON, DC, 20007, US

(73) Assignee: HYDRO-QUEBEC

(21) Appl. No.: 10/459,594

(22) Filed: Jun. 12, 2003

(51) Int. Cl. B60T 7/00; F16D 65/36

(52) U.S. Cl. 188/156; 303/15; 303/113.4; 188/157; 188/1.11 E

(57) ABSTRACT

A braking system for electric vehicles that gives a driver the feel of a conventional hydraulic braking system while maximizing the recuperation of electrical power is described herein. A single brake pedal is used to control both electric and hydraulic braking assemblies. A feedback force generator is provided to give the driver the impression that a completely hydraulic braking system is used. Therefore, the driver is not inclined to further depress the pedal, thereby preventing the premature activation of the hydraulic braking system.

### FIELD OF THE INVENTION

The present invention relates, to a braking systems. More specifically, the present invention is concerned with a braking system for electric vehicles.

### BACKGROUND OF THE INVENTION

Electric vehicles are well known in the art, both in their pure electric form and in their hybrid form.

It is also widely known that it is possible to recuperate a portion of the electric energy that was used to accelerate the vehicle by using the electric motor as a generator when the driver wishes to slow down or to stop the vehicle. Indeed, when the electric motor of the vehicle is used as a generator, it slows down the vehicle while generating electricity that may be stored in the battery of the vehicle or in other electric energy storage means.

It is widely accepted that a conventional hydraulic driven braking assembly is also desirable on an electric vehicle for a variety of reasons.

Generally, in braking systems for electric vehicles, the electric braking assembly is used for slowing down the vehicle, while the hydraulic braking assembly is activated when the driver wishes to completely stop the vehicle. Generally stated, the first portion of the displacement of a single brake pedal activates the electric braking assembly while the second portion of the displacement of the brake pedal triggers both the electric and the hydraulic braking assemblies. This way, when the driver gently presses on the brake pedal, only the electric braking is activated and electric energy is recuperated, and when the driver depresses the brake pedal further both the electric and hydraulic braking are activated to stop the vehicle.

In the conventional braking system described hereinabove, a single brake pedal is used to control both electric and hydraulic braking assemblies. This contributes to give the driver conventional braking feel. However, the force feedback, i.e. the resistance force opposing the pedal movement, is solely applied to the brake pedal by the hydraulic braking assembly. Therefore, when the pedal is only lightly depressed, there is no negative force feedback provided to the user who tends to depress the pedal further in order to obtain the feel characterizing the usual hydraulic feedback. This premature activation of the hydraulic braking assembly results in a portion of reusable electric power being dissipated in heat.

### OBJECTS OF THE INVENTION

An object of the present invention is therefore to provide an improved electric vehicle braking system.

### SUMMARY OF THE INVENTION

More specifically, in accordance with the present invention, there is provided A braking system for an electric vehicle, said braking system comprising:

a hydraulic braking assembly including a brake pedal;

an electric braking assembly including a sensor so mounted to said brake pedal as to detect a displacement of the brake pedal along a first direction; and

a feedback force generator so associated with said brake pedal as to selectively generate a negative feedback force in a second direction opposite said first direction;

wherein said feedback force generator is responsive to the displacement detected by said sensor.

According to another aspect of the present invention, there is provided a feedback force generator for an electric vehicle provided with a hydraulic braking assembly and an electric braking assembly both actuated by a common brake pedal, said electric braking assembly including a sensor so associated with the brake pedal as to detect a displacement of the brake pedal along a first direction, wherein said feedback force generator includes a force applying mechanism so mounted between the brake pedal and said vehicle as to selectively apply, on the brake pedal, a negative feedback force in a second direction opposite said first direction in response to the displacement detected by the sensor

According to yet another aspect of the present invention, there is provided a An electric vehicle comprising:

a hydraulic braking assembly including a brake pedal;

an electric braking assembly including a sensor so associated with said brake pedal as to detect a displacement of said brake pedal along a first direction; and

a feedback force generator so associated with said brake pedal as to selectively generate a negative feedback force in a second direction opposite said first direction;

wherein said feedback force generator is responsive to the displacement of the brake pedal detected by said sensor.

According to a fourth aspect of the present invention, there is provided a method for braking an electric vehicle, comprising

connecting a brake pedal to a hydraulic braking assembly and to an electric braking assembly;

sensing a displacement of the brake pedal along a first direction;

measuring at least one parameter relative to the vehicle;

selectively generating a negative feedback force on said brake pedal in a second direction opposite the first direction in response to both the detected movement of the brake pedal and the at least one parameter measured.

It is to be noted that the expression “electric vehicle” is to be construed as meaning pure electric vehicles and any type of hybrid vehicles where at least one of the wheels is directly or indirectly connected to an electric motor, and the like.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a schematic view of a braking system according to a first embodiment of the present invention, when in a unused state;

FIG. 2 is a schematic view of the braking system of FIG. 1, when in an electric braking state;

FIG. 3 is a schematic view of the braking system of FIG. 1, when in an electric and mechanical braking state;

FIG. 4 is a schematic view of a braking system according to a second embodiment of the present invention; and

FIG. 5 is a schematic graphic representation of a possible blend between the capacities of the electric and hydraulic brake assemblies vs. the brake pedal depression.

### DESCRIPTION OF THE EMBODIMENTS

In a nutshell, the present invention provides a braking system that gives the driver the feel of a conventional hydraulic braking system while maximizing the recuperation of electric power.

Generally stated, an aspect of the present invention calls for a feedback force generator to give the driver an uniform feedback while blending electric and hydraulic braking system. Hence, the driver is not inclined to further depress the pedal to reduce the speed of the vehicle, thereby preventing premature activation of the hydraulic braking assembly.

In another aspect of the present invention, the feedback force generator is used as a hydraulic braking assistance by creating, in certain conditions, a positive force in the direction of the brake pedal.

In yet another aspect of the present invention, the feedback force generator is so controlled that the blending of electric and hydraulic braking system produces a supplementary positive feedback force at the end of pedal stroke to compensate for hydraulic braking system saturation.

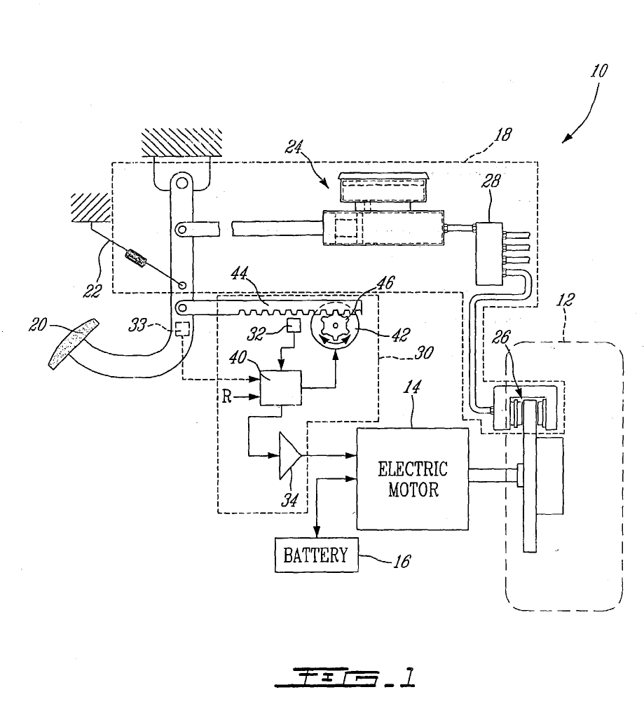

Turning now to the FIGS. 1 to 3 of the appended drawings, an electric vehicle braking system 10 according to a first embodiment of the present invention will be described.

The braking system 10 is designed to be used in an electric vehicle (not shown) including four wheels 12 (only one shown) mechanically connected to an electric motor 14 powered by a power source such as, for example, a battery 16. Of course, not all the wheels 12 need to be connected to the motor 14, and more than one electric motor 14 may be provided.

The braking system 10 includes a conventional hydraulic braking assembly 18 and an electric braking assembly 30, as will be described hereinbelow.

The conventional hydraulic braking assembly 18 comprises a brake pedal 20, a biasing element in the form of a spring 22, a master cylinder 24 connected to the brake pedal 20, and calipers 26 supplied with hydraulic braking fluid via a manifold 28. The operation of such a hydraulic braking assembly is believed well known to one skilled in the art and, for concision considerations, will not be further described herein.

The electric braking assembly 30 includes a sensor in the form of a displacement transducer 32 associated with the brake pedal 20; an electric motor controller 34 to which the motor 14 is connected; and a feedback force generator. The feedback force generator comprises a controller 40, an electric motor 42 fixedly mounted to the vehicle and a rack-and-pinion assembly including a rack 44 and a pinion 46 mounted to the rotating shaft of the motor 42. Obviously, the controllers 34 and 40 may have many other functions.

As will be discussed hereinbelow, the feedback force generator provides brake pedal negative feedback when the pedal is slightly depressed, i.e. before the hydraulic braking assembly 18 is activated.

The displacement transducer 32 can be, for example, an optical position encoder that detects the movement of the brake pedal 20 by detecting the longitudinal displacement of the rack 44 and sends this information to the controller 40. The controller 40, in turn, sends data to the electric motor controller 34 and controls the motor 42 to thereby simultaneously start a braking action and apply a negative feedback force on the brake pedal 20 as will be described hereinbelow.

Of course, one skilled in the art will understand that other types of sensors could be used such as, for example, a rotary position encoder that would be provided on the shaft of the electric motor 42 to detect and measure the displacement of the pedal 20.

The pinion 46 contacts the rack 44 so that counter-clockwise rotation of the motor 42 causes a negative feedback force on the brake pedal 20, i.e. opposed to the movement of the brake pedal 20.

The operation of the electric vehicle braking system 10 will now be described.

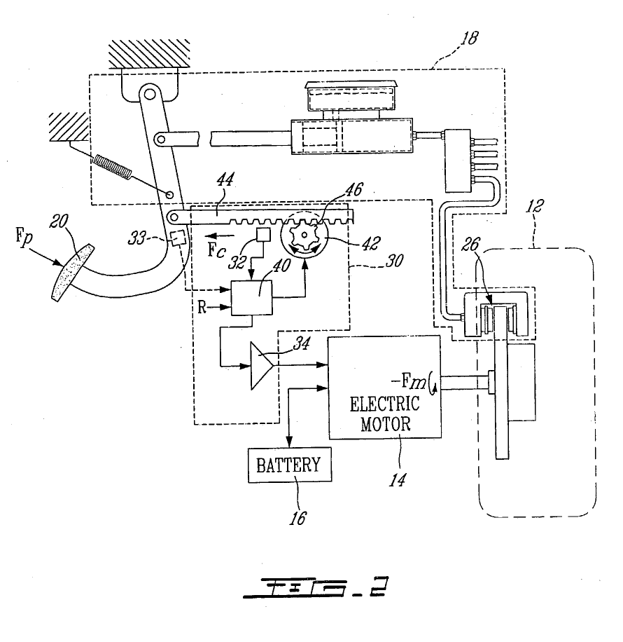

In contrast to FIG. 1, which shows the system 10 when no force is applied to the brake pedal 20 by the driver, FIG. 2 illustrates the system when a slight pressure “Fₚ” is applied to the brake pedal 20. This pressure is translated in a movement of the rack 44 detected by the sensor 32. As can be seen from the calipers 26, this displacement is not sufficient to activate the hydraulic braking system 18.

As mentioned hereinabove, the pressure Fₚ causes a movement of the rack 44 that is detected by the displacement transducer 32 and supplied to the controller 40 that instructs the controller 34 and the motor 42 as will be described hereinbelow.

The controller 40 uses variables, represented in the figures by a single variable “R”, to determine the amplitude of forces to be generated by the motors 14 and 42. The variable R may take into account many parameters, such as, for example, the speed of the vehicle, the displacement of the rack 44, the duration since the beginning of the application of the displacement, the charge of the battery, etc.

The appended drawings illustrate that the same variable R is used to determine the amplitude of forces to be generated by the motors 14 and 42. However, one skilled in the art would understand that different parameters could be used to control the motors 14 and 42.

When these parameters have been taken into consideration, a signal is supplied to the electric motor 14 via the controller 34 to create an electrical braking force “−Fₘ” that slows the vehicle down and recuperates a portion of the electric energy that is be stored in the battery 16.

Simultaneously, a signal is supplied to the electric motor 42 to cause a counter-clockwise rotation of the gear 46, which, in turn, generates a force “F_{c}” opposed to the force Fₚ and applied to the pedal 20 to simulate the feedback of a conventional hydraulic braking assembly. The feedback force generator being thereby responsive to the displacement of the rack 44 detected by the displacement transducer 32.

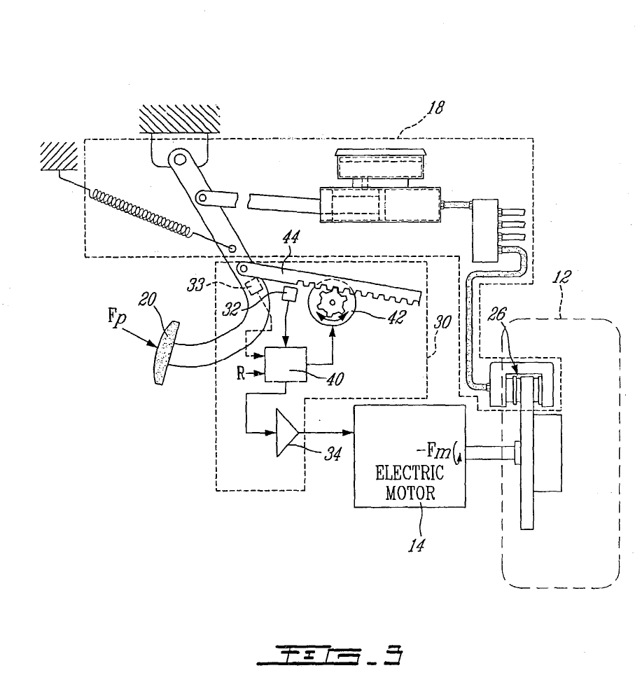

FIG. 3 of the appended drawings illustrates a further displacement of the brake pedal 20 by the driver. As can be seen from this figure, a greater force Fₚ is applied onto the pedal 20 causing the conventional hydraulic braking assembly 18 to be activated. This activation causes the caliper 26 to mechanically slow down the rotation of the wheel 12.

It is to be noted that since the conventional braking assembly 18 is activated, the controller 40 no longer supplies a signal to the motor 42 to apply a negative feedback force. Of course, when the passage from the electrical braking regime (FIG. 2) to the mixed electrical and hydraulic braking regime (FIG. 3) is gradual, the negative feedback force F_{c} applied to the pedal 20 by the motor 42 may be gradually reduced to ensure that the driver does not feel an undesired kick-back in the pedal 20.

It will easily be understood by one skilled in the art that, even in the mixed electrical and hydraulic braking regime of FIG. 3, the controller 34 sends a signal to the motor 14 to apply the electrical braking force −Fₘ in order to save as much electrical power as possible, thereby further optimizing the braking performances of the vehicle.

An advantage of the system 10 is the possibility to be used as a hydraulic braking assisting assembly. Indeed, in certain conditions, the controller 40 may cause the motor 42 to rotate clockwise, thereby assisting the hydraulic braking by creating a positive feedback force in the direction of the movement of the brake pedal.

One skilled in the art will understand that only the program run by the controller has to be changed to give this functionality to the system 10.

It is to be noted that should this feature be provided on the system 10, a pressure sensor, such as for example a strain gage 33, would be advantageous to detect the pressure applied to the brake pedal when the hydraulic brake are used since the movement of the brake pedal is often negligible in these circumstances. This strain gage 33 would supply data to the controller 40.

Another advantage is that the conventional electric resistor used to dissipate heat when the batteries are full and electric braking is applied may optionally be omitted. Indeed, when the battery is full, the negative feedback provided by the feedback force generator may be reduced to thereby promote the use of the hydraulic braking assembly.

It is to be noted that an optional clutch system, or other similar assemblies, may be provided between the motor 42 and the pinion 46 to thereby place the pinion 46 in a “freewheeling” state should a problem be detected in the motor 42 or its control.

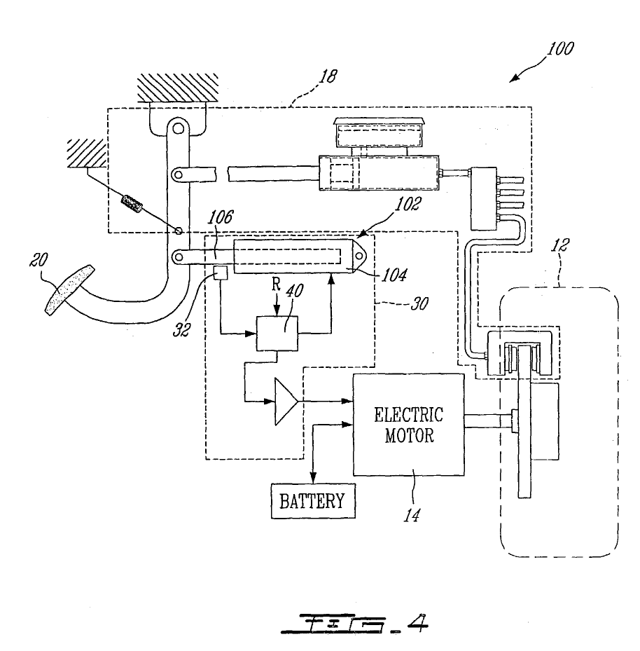

Turning now to FIG. 4 of the appended drawings, a braking system 100 according to a second embodiment of the present invention will be described.

The braking system 100 is very similar to the system 10 of FIGS. 1 to 3. Therefore, for concision purposes, only the differences between these two systems will be described hereinbelow.

Generally stated, the main difference between the system 100 and the system 10 lies in the nature of the feedback force generator. Indeed, while a motor/rack-and-pinion assembly is used in the system 10, a cylinder 102 having a body 104 and a piston 106 is used in the system 100. The piston 106 is physically connected to the brake pedal 20, so that a movement of the piston causes a negative feedback force on the brake pedal. As will be understood by one skilled in the art, the cylinder 102 may be a fluid cylinder or an air cylinder.

One skilled in the art will understand that other types of force feedback generators could be used such as, for example, a linear electric motor or a solenoid assembly.

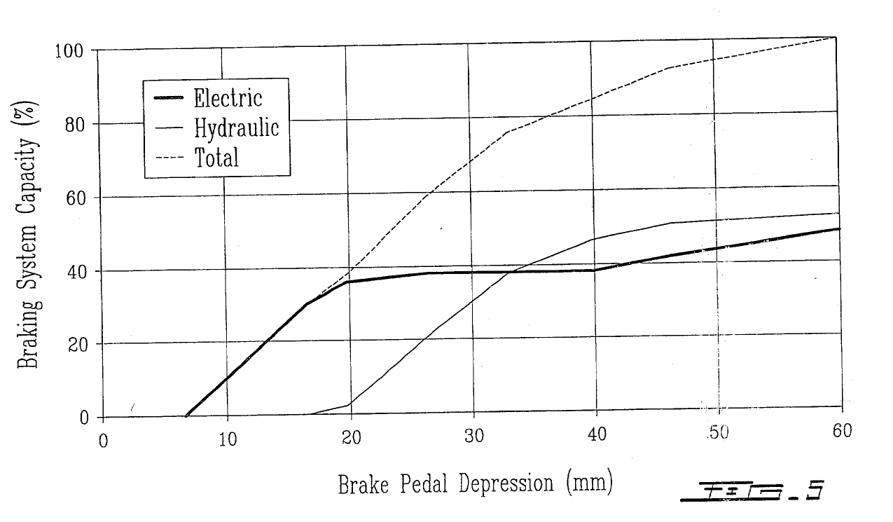

Turning now to FIG. 5 of the appended drawings, a possible blending of the capacities of the electric and hydraulic braking assemblies will be briefly described.

As can be seen from this figure, the electric braking assembly (thick full line) is the first to be activated and is the only braking assembly activated for a given range of motion of the pedal. During this first stage, the feedback force generator of the present invention is activated to offer a negative feedback, as described hereinabove.

The hydraulic braking assembly (thin full line) is then activated. At the beginning of this second stage, the feedback force generator decreasingly offers resistance as the hydraulic pressure builds.

Finally, to help linearize the total braking capacity vs. brake pedal depression curve shown in dashed lines in FIG. 5, the electric braking capacity is slightly increased in a third stage to partially compensate for the saturation of the hydraulic braking system. It is to be noted that the feedback force generator may be activated in the opposite direction to provide a positive feedback force to assist the user as discussed hereinabove.

It is to be noted that while the electric motor 14 has been shown herein as being directly connected to the wheel 12, the present invention is also concerned with vehicles having a central electric motor connected to two or more wheels.

Moreover, people skilled in the art will understand that the controllers 34 and 40 could be embodied in a single controller (not shown) and that this controller could control the entire operation of the vehicle.

Although the present invention has been described hereinabove by way of preferred embodiments thereof, it can be modified, without departing from the spirit and nature of the subject invention as defined in the appended claims.

1. A braking system for an electric vehicle, said braking system comprising:
a hydraulic braking assembly including a brake pedal;
an electric braking assembly including a sensor so mounted to said brake pedal as to detect a displacement of the brake pedal along a first direction; and
a feedback force generator so associated with said brake pedal as to selectively generate a negative feedback force in a second direction opposite said first direction;
wherein said feedback force generator is responsive to the displacement detected by said sensor.

2. The braking system for an electric vehicle according to claim 1, wherein said electric braking assembly further includes a controller to which said sensor and said feedback force generator are connected.

3. The braking system for an electric vehicle according to claim 1, wherein said feedback force generator includes a fixed portion mounted to the vehicle and a movable portion provided between said fixed portion and said brake pedal.

4. The braking system for an electric vehicle according to claim 3, wherein said fixed portion includes an electric motor provided with a pinion and wherein said movable portion includes a rack so associated with said pinion that a rotation of said electric motor in a predetermined direction causes said negative feedback force on said brake pedal.

5. The braking system for an electric vehicle according to claim 1, wherein said feedback force generator includes a cylinder having a body fixed to the vehicle and a piston connected to said brake pedal so that a movement of said piston causes said negative feedback force on said brake pedal.

6. The braking system for an electric vehicle according to claim 5, wherein said cylinder is selected from the group including fluid cylinders and air cylinders.

7. The braking system for an electric vehicle according to claim 1, wherein said feedback force generator includes a linear motor provided between the electric vehicle and said brake pedal.

8. The braking system for an electric vehicle according to claim 1, wherein said feedback force generator includes a solenoid assembly provided between the electric vehicle and said brake pedal.

9. The braking system for an electric vehicle according to claim 1, wherein said feedback force is determined by taking into account at least one parameter selected from the group consisting of the speed of the vehicle, the displacement of said brake pedal, a duration since the beginning of the displacement of said brake pedal and a charge of a battery of the vehicle.

10. The braking system for an electric vehicle according to claim 1, wherein said sensor is a displacement transducer.

11. The braking system for an electric vehicle according to claim 10, wherein said displacement transducer includes a position encoder.

12. A feedback force generator for an electric vehicle provided with a hydraulic braking assembly and an electric braking assembly both actuated by a common brake pedal, said electric braking assembly including a sensor so associated with the brake pedal as to detect a displacement of the brake pedal along a first direction, wherein said feedback force generator includes a force applying mechanism so mounted between the brake pedal and said vehicle as to selectively apply, on the brake pedal, a negative feedback force in a second direction opposite said first direction in response to the displacement detected by the sensor.

13. The feedback force generator according to claim 12, wherein said force applying mechanism includes a fixed portion mounted to the vehicle and a movable portion provided between said fixed portion and the brake pedal.

14. The feedback force generator according to claim 13, wherein said fixed portion includes an electric motor provided with a pinion and said movable portion includes a rack associated with said pinion so that a rotation of said electric motor in a predetermined direction causes said negative feedback force on the brake pedal.

15. The feedback force generator according to claim 12, wherein said feedback force generator includes a cylinder having a body fixed to the vehicle and a piston connected to the brake pedal so that a movement of said piston causes said negative feedback force on the brake pedal.

16. The feedback force generator according to claim 15, wherein said cylinder is selected from the group including fluid cylinders and air cylinders.

17. The braking system for an electric vehicle according to claim 12, wherein said feedback force generator includes a linear motor provided between the electric vehicle and the brake pedal.

18. The braking system for an electric vehicle according to claim 12, wherein said feedback force generator includes a solenoid assembly provided between the electric vehicle and the brake pedal.

19. The feedback force generator according to claim 12, wherein said negative feedback force is determined by taking into account at least one parameter selected in the group consisting of the speed of the vehicle, the displacement of the brake pedal, a duration since the beginning of the displacement of the brake pedal and a charge of a battery of the vehicle.

20. The feedback force generator according to claim 12, wherein said sensor includes a displacement transducer.

21. The feedback force generator according to claim 20, wherein said displacement transducer includes a position encoder.

22. An electric vehicle comprising:
a hydraulic braking assembly including a brake pedal;
an electric braking assembly including a sensor so associated with said brake pedal as to detect a displacement of said brake pedal along a first direction; and
a feedback force generator so associated with said brake pedal as to selectively generate a negative feedback force in a second direction opposite said first direction;
wherein said feedback force generator is responsive to the displacement of the brake pedal detected by said sensor.

23. A method for braking an electric vehicle, comprising:
connecting a brake pedal to a hydraulic braking assembly and to an electric braking assembly;
sensing a displacement of the brake pedal along a first direction;
measuring at least one parameter relative to the vehicle;
selectively generating a negative feedback force on said brake pedal in a second direction opposite the first direction in response to both the detected movement of the brake pedal and the at least one parameter measured.

24. The method according to claim 23, wherein said sensing is done via a displacement transducer.

25. The method according to claim 23, wherein said act of measuring at least one parameter includes measuring at least one parameter selected in the group including the speed of the vehicle, a duration since the beginning of the displacement of the brake pedal and a charge of a battery of the vehicle.

26. The braking system for an electric vehicle according to claim 1, wherein said negative feedback force is reduced when said hydraulic braking assembly is activated.
